(19) United States
(12) Patent Application Publication
(10) Pub. No.: US 2014/0107952 A1
(43) Pub. Date: Apr. 17, 2014

(54) CAVITATION EVALUATING DEVICE

(71) Applicant: Azbil Corporation, Tokyo (JP)

(72) Inventors: Ryosuke KINOSHITA, Tokyo (JP); Shinichi TSUNODA, Tokyo (JP)

(73) Assignee: AZBIL CORPORATION, Tokyo (JP)

(21) Appl. No.: 14/051,050

(22) Filed: Oct. 10, 2013

(30) Foreign Application Priority Data
Oct. 11, 2012 (JP) 2012-226348

(51) Int. Cl. G01N 19/00

(52) U.S. Cl. CPC G01N 19/00
USPC 702/50

(57) ABSTRACT

A downstream side fluid pressure is a fluid pressure of a fluid stagnation portion within a flow path that is internal to a regulator valve. A pressure ratio that is internal to the regulator valve is calculated from an upstream side fluid pressure, the downstream side fluid pressure, and a saturated vapor pressure for the fluid, calculated from a fluid temperature. A pressure ratio table that establishes relationships between a threshold value and a relative flow coefficient of the regulator valve, where the pressure ratio that is internal to the regulator valve, at the time at which the occurrence of cavitation within the regulator valve begins, is defined as the threshold value, is created and stored in a storing portion. The pressure ratio table is used to evaluate whether or not there is cavitation.

### CROSS REFERENCE TO RELATED APPLICATION

This application claims priority under 35 U.S.C. §119 to Japanese Patent Application No. 2012-226348, filed on Oct. 11, 2012, the entire content of which being hereby incorporated herein by reference.

### FIELD OF TECHNOLOGY

The present invention relates to a cavitation evaluating device for evaluating whether or not there is cavitation in a regulator valve through which a fluid flows.

### BACKGROUND

Conventionally, regulator valves are installed in pipes for distributing cold and hot water for building air-conditioning in office buildings, schools, and the like. In these regulator valves, the degree of opening is changed in order to control the flow rate or pressure of the fluid that flows through the pipes. At this time, cavitation (a phenomenon wherein there is the creation and collapse of gas bubbles due to a drop in the pressure in the fluid) may be produce within the regulator valve due to the pressure dropping below the saturated vapor pressure due to the change in the differential pressure across the regulator valve.

When cavitation occurs, noise and vibration is produced, which may have an adverse effect on the living space. Moreover, when a regulator valve operates continuously in this state, the result may be a failure in the regulator valve or in the pipe downstream from the valve, leading to a serious situation wherein the fluid leaks to the outside, due to cavitation erosion. Consequently, it is desirable to be able to constantly evaluate on-line the occurrence of cavitation, enabling early handling thereof.

Because of this, when the conventional technology is used, a method can be considered wherein the relationship between the pressure ratio X_{F} across the regulator valve and the sound level is calculated for various degrees of opening, and the pressure ratio X_{F} at the commencement of the occurrence of cavitation is set as a threshold value X_{F}th for each degree of opening, and whether or not there is cavitation is evaluated based on a comparison of the pressure ratio X_{F} and the threshold value X_{F}th for the current degree of opening. See, for example, JISB2005-8-2 (2008).

FIG. 14 shows the state wherein the relationship between the pressure ratio X_{F} across the regulator valve and the sound level is calculated. In this figure, 101 is a regulator valve that is provided within a pipe L, 102 is an upstream side fluid pressure detecting device for detecting the fluid pressure on the upstream side of the regulator valve 101 (the upstream side fluid pressure) P1, 103 is an downstream side fluid pressure detecting device for detecting the fluid pressure on the downstream side of the regulator valve 101 (the downstream side fluid pressure) P2, 104 is a sound meter for detecting the sound level at a position a certain distance away from the regulator valve 101, and 109 is a fluid temperature detecting device for detecting the temperature T of the fluid that flows through the regulator valve 101 (the fluid temperature T).

In order to calculate the relationships between the pressure ratios X_{F} across the regulator valve 101 and the sound levels, a degree of opening is set for the regulator valve 101, and the pressure ratio X_{F} across the regulator valve 101 is calculated as X_{F}=(P1−P2)/(P1−Pv). Note that in the equation for calculating the pressure ratio X_{F}, Pv is the saturated vapor pressure, where this value is calculated uniquely as a mathematical function of the fluid temperature T. Given this, at this time the noise level Nz is measured by the noise meter 104. This operation is performed repetitively as the pressure ratio X_{F} is varied. The relationship between the pressure ratio X_{F} and the noise level Nz, measured in this way, typically exhibits a trend such as illustrated in FIG. 15.

In FIG. 15, the point Y1 is a point that indicates the state wherein the sound level increases sharply due to the production and collapse of cavitation, the point Y2 is a point that indicates the state wherein the production and collapse of cavitation occurs steadily, and the point Y3 is a point that indicates the state wherein the flow rate does not increase even when the differential pressure is increased. The pressure ratio X_{F} at the point Y1 is known as the onset X_{Fz}, the pressure ratio X_{F} at the point Y2 is known as the critical X_{Feri}, and the pressure ratio X_{F} at the point Y3 is known as the blockage X_{Fch}. See, for example, Hiroharu KATO, Fundamentals and Recent Advancements in Cavitation, Makishoten 1999, and Kazuyoshi YAMAMOTO, Valves and Cavitation, Valve Technical Report 2004.

That is, in FIG. 15, the onset X_{Fz} indicates the pressure ratio X_{F} when the occurrence of cavitation starts in the regulator valve 101, the critical X_{Feri} indicates the pressure ratio X_{F} at the beginning of the steady occurrence of cavitation, and the blocked X_{Fch} indicates the pressure ratio X_{F} when the state becomes one wherein the flow rate does not increase even when the differential pressure between the upstream and low stream sides of the regulator valve 101 increases.

The relationship between the pressure ratio X_{F} and the noise level Nz varies for various degrees of opening of the regulator valve 101. Because of this, the relationship between the pressure ratio X_{F} and the noise level Nz is calculated for various degrees of valve opening of the regulator valve 101. In the relationships that are calculated for the pressure ratio X_{F} and the noise level Nz, the onset X_{Fz} that is the pressure ratio X_{F} at which the occurrence of cavitation starts is defined as a threshold value X_{F}th, where the threshold value X_{F}th is established for various degrees of opening.

Given this, when performing an evaluation on-line, the upstream side fluid pressure P1 and the downstream side fluid pressure P2 are detected for the regulator valve 101, the valve opening θ of the regulator valve 101 is detected, and the threshold value X_{F}th at the current valve opening θ is compared to the current pressure ratio X_{F}, as illustrated in FIG. 16, to evaluate whether or not there is the occurrence of cavitation. Note that in FIG. 16, 105 is a valve opening detecting device for detecting the degree of valve opening θ of the regulator valve 101, and 100 is a cavitation evaluating device, where the evaluation of whether or not there is cavitation is performed by the cavitation evaluating device 100. The relationships between the degrees of opening θ and the threshold values X_{F}th are stored as a pressure ratio table in the cavitation evaluating device 100.

In the conventional cavitation evaluating device 100, set forth above, the upstream side fluid pressure P1 and the downstream side fluid pressure P2 of the regulator valve 101 are detected at positions wherein the pressures have stabilized, separated by specific distances, in straight pipe lengths, from the regulator valve 101 (2D on the upstream side and 6D on the downstream side (where D is the nominal diameter of the valve)). However, in practice the state of installation of the regulator valve 101 is not necessarily limited to one wherein a straight pipe with the same diameter as the regulator valve is connected, depending on the circumstances such as the space available for installation, instrumentation, and the like.

That is, as illustrated in FIG. 18(a), while it would be good if a pipe L of the same diameter as the opening diameter 1 of the regulator valve 101 were to be connected to the regulator valve 101, the installation environment is not necessarily limited to such an environment, but rather, as one example, instead the situation may be one wherein a reducing pipe (reducer) 107 with an opening diameter 2 of the pipe L is larger than the opening diameter 1 of the regulator valve 101 is connected between the regulator valve 101 and the pipe L, as illustrated in FIG. 18(b). Moreover, as illustrated in FIG. 18(c), in some cases a bent pipe (an elbow) 108 may be installed between the regulator valve 101 and the pipe L.

When a reducer 107 or an elbow 108, or the like, is installed between the regulator valve 101 and the pipe L, the relationship between the state of occurrence of cavitation in the regulator valve 101 and the pressure ratio X_{F} is changed by the pressure loss therein, making it impossible to evaluate accurately the occurrence of cavitation from the pressure ratio table (the relationships between the degrees of valve opening θ and the threshold values X_{F}th) that is established in advance.

Note that while it is possible to increase the accuracy of the evaluation of cavitation through preparing pressure ratio tables depending on the installation environments for the regulator valve 101, doing so would require increasing the pressure ratio tables that are established each time there is an increase in the variations of the installation environment for the regulator valve 101, requiring an excessive amount of labor to prepare the pressure ratio tables, and requiring large amounts of memory for the increasing number of pressure ratio tables.

FIG. 17 shows the relationships between the pressure ratio X_{F} across the regulator valve and the noise level Nz for the case wherein the installation environment for the regulator valve 101 is straight (a straight pipe), a reducer (a reducing pipe), and an elbow (a bent pipe).

In FIG. 17, Curve I illustrates a case wherein the installation environment for the regulator valve 101 is straight, the Curve II illustrates a case of a reducer, and Curve III illustrates a case of an elbow. When the installation environment for the regulator valve 101 is straight, the onset X_{Fz} is X_{Fzs}, for the reducer the onset X_{Fz} is X_{Fzr}, and for the elbow the onset X_{Fz} is X_{Fze} (where X_{Fzs}≠X_{Fzr}≠X_{Fze}). In this way, it is necessary to prepare pressure ratio tables depending on the installation environment for the regulator valve 101 because the relationships between the pressure ratios X_{F} and the noise levels Nz vary, and the pressure ratios X_{F} wherein the occurrences of cavitation start (the onset X_{Fz}) vary, depending on the installation environment.

The present invention was created in order to solve such a problem, and an aspect thereof is to provide a cavitation evaluating device able to perform the evaluation of cavitation with high accuracy, without the preparation of a large number of different pressure ratio tables, for variations of installation environments (pipe layouts) for the regulator valves.

### SUMMARY

In order to achieve the aspect set forth above, the present invention provides a cavitation evaluating device for evaluating whether or not there is cavitation in a regulator valve in which a fluid is flowing. The cavitation evaluating device includes an upstream side fluid pressure detecting portion that detects, as an upstream side fluid pressure Pv1, a fluid pressure of a flow path that is internal to the regulator valve, on the upstream side of a valve plug of the regulator valve, a downstream side fluid pressure detecting portion that detects, as an downstream side fluid pressure Pv2, a fluid pressure of a fluid stagnation portion, that produces stagnation in a flow of a fluid in flow path that is internal to the regulator valve, on the downstream side of a valve plug of the regulator valve, a fluid temperature detecting portion that detects, as a fluid temperature T, a temperature of the fluid, a saturated vapor pressure calculating portion that calculates a saturated vapor pressure Pv of the fluid from the fluid temperature T that is outputted from the fluid temperature detecting portion, a pressure ratio calculating portion that calculates a pressure ratio X_{Fv} that is internal to the regulator valve from the upstream side fluid pressure Pv1 that is detected by the upstream side fluid pressure detecting portion, the downstream side fluid pressure Pv2 that is detected by the downstream side fluid pressure detecting portion, and the saturated vapor pressure Pv that is calculated by the saturated vapor pressure calculating portion, a storing portion that stores a pressure ratio table that establishes relationships between threshold values X_{Fv}th and a mathematical function of degrees of valve opening of the regulator valve, wherein the pressure ratio X_{Fv} that is internal to the regulator valve, at the time at which the occurrence of cavitation begins in the regulator valve, is defined as the threshold value X_{Fv}th, and an evaluating portion that evaluates whether or not there is cavitation in the regulator valve by finding, from the pressure ratio table that is stored in the storing portion, the threshold value X_{Fv}th corresponding to a mathematical function of the current degree of opening of the regulator valve, and compares this threshold value X_{Fv}th that has been found to the current pressure ratio X_{Fv} that is internal to the regulator valve that was calculated by the pressure ratio calculating portion.

In the present invention, a pressure ratio X_{Fv} (X_{FV}=(Pv2−Pv1)/(Pv1−Pv)) internal to the regulator valve is established from an upstream side fluid pressure Pv1 that is the fluid pressure of the flow path internal to the regulator valve on the upstream side of the valve plug of the regulator valve, a downstream side fluid pressure Pv2 that is the fluid pressure of the fluid stagnation portion in the flow path internal to the regulator valve on the downstream side of the valve plug of the regulator valve, and a saturated vapor pressure Pv for the fluid, calculated from the fluid temperature T. Moreover, the pressure ratio X_{Fv} internal to the regulator valve at which the occurrence of cavitation begins in the regulator valve is defined as a threshold value X_{Fv}th, where a pressure ratio table that establishes the relationships between this threshold value X_{Fv}th and a mathematical function of the degree of valve opening in the regulator valve (for example, a relative flow coefficient, or the degree of valve opening) is stored in the storing portion.

Moreover, at the time of an on-line evaluation, the upstream side fluid pressure Pv1, the downstream side fluid pressure Pv2, and the fluid temperature T are detected, and the saturated vapor pressure Pv of the fluid is calculated from the fluid temperature T, after which the current pressure ratio X_{Fv} is calculated from the upstream side fluid pressure Pv1, the downstream side fluid pressure Pv2, and the saturated vapor pressure Pv, the threshold value X_{Fv}th corresponding to the mathematical function of the current degree of opening of the regulator valve is found from the pressure ratio table that is stored in the storing portion, and an evaluation as to whether or not there is cavitation in the regulator valve is performed through comparing the current pressure ratio X_{Fv} to the threshold value X_{Fv}th that has been found.

The cavitation that occurs in the regulator valve is understood to be caused by the pressure on the upstream side of a restricting portion (a reduced flow portion) and the flow speed of the flow through the reduced flow portion across the valve unit within the regulator valve. The upstream side fluid pressures P1 measured at locations that are separated at specific distances, in straight pipe lengths, from the regulator valve, will have pressure relationships that vary depending on the pressure loss conditions, such as reducers, elbows, or the like, that are installed before or after the regulator valve, even given identical flow speeds within the regulator valve. Because of this, when evaluating cavitation in a regulator valve based on the state of occurrence of cavitation understood based on the upstream side fluid pressures P1 measured at locations that are separated at specific distances, in straight pipe lengths, from the regulator valve, an appropriate evaluation may not be possible depending on the installation environment of the valve. On the other hand, because the pressure across the reduced flow portion within the regulator valve is affected by the pressure loss of the regulator valve alone, the pressure relationship does not change, there is little influence of the piping before and after the regulator valve. Consequently, if a pressure ratio table is used wherein the pressure ratio X_{Fv} internal to the regulator valve (across the restricted flow portion thereof) at the beginning of the occurrence of cavitation in the regulator valve is used as the threshold value X_{Fv}th and a pressure ratio table for establishing the relationships between this threshold value X_{Fv}th and a mathematical function of the degrees of opening of the regulator valve is used, then it becomes possible to evaluate, using only this pressure ratio table (a single pressure ratio table), whether or not there is cavitation, unaffected by constraints in the installation environment of the regulator valve.

In particular, in the present invention the fluid pressure at a fluid stagnation portion, wherein stagnation is produced in the flow of the fluid in a flow path that is internal to the regulator valve on the side that is downstream of the valve unit in the regulator valve is detected as the downstream side fluid pressure Pv2, so that the downstream side fluid pressure Pv2 is detected at a fluid stagnation portion that is not affected by the dynamic pressure, thereby further increasing the cavitation evaluation accuracy. Note that while in the present invention a fluid pressure in the flow path that is internal to the regulator valve on the upstream side of the valve unit in the regulator valve is detected as the upstream side fluid pressure Pv1, the pressure of a fluid that is a combined flow after causing fluid from a plurality of points to flow in, so as to smooth the variability in the pressure distribution due to a biased flow may be detected as the upstream side fluid pressure. Moreover, while in the present invention the pressure ratio X_{Fv} wherein the occurrence of cavitation starts in the regulator valve is used as the threshold value X_{Fv}th, this threshold value X_{Fv}th need not necessarily be the onset X_{Fvz}, but instead may be a pressure ratio that is set arbitrarily between this onset X_{Fvz} and the critical X_{Fveri}.

Given the present invention, a pressure ratio X_{Fv} that is internal to the regulator valve is established as a ratio of the upstream side fluid pressure Pv1 and the downstream side fluid pressure Pv2, from an upstream side fluid pressure Pv1 that is a fluid pressure of the flow path that is internal to the regulator valve on the upstream side of the valve plug in the regulator valve, a downstream side fluid pressure Pv2 that is a fluid pressure of the fluid stagnation in the flow path that is internal to the regulator valve on the downstream side of the valve plug in the regulator valve, and a saturated vapor pressure Pv of the fluid, found uniquely from the fluid temperature T, and the pressure ratio X_{Fv}, that is internal to the regulator valve, wherein the occurrence of cavitation begins in the regulator valve, is defined as a threshold value X_{Fv}th, where a pressure ratio table that defines the relationships between the threshold values X_{Fv}th and a mathematical function of the degrees of opening of the regulator valve is stored in a storing portion, where the threshold value X_{Fv}th corresponding to a mathematical function of the current degree of opening of the regulator valve is found in the pressure ratio table, and the present pressure ratio X_{Fv} that is internal to the regulator valve, calculated from the upstream side fluid pressure Pv1 and the downstream side fluid pressure Pv2, is compared to this threshold value X_{Fv}th that has been found, thus making it possible to evaluate the cavitation with high accuracy, without preparing a plurality of pressure ratio tables for variations in the installation environment of the regulator valve (pipe layouts).

### BRIEF DESCRIPTIONS OF THE DRAWINGS

FIG. 1 is a diagram illustrating an example of a cavitation evaluating system for a regulator valve that uses the cavitation evaluating device according to the present invention.

FIG. 2 is a cross-sectional diagram of the critical portions of a regulator valve in the cavitation evaluation system.

FIG. 3 is a diagram illustrating a state wherein the relationships between the pressure ratios X_{Fv} internal to the regulator valve and the noise levels are calculated.

FIG. 4 is a diagram illustrating the relationships between the pressure ratios X_{Fv} that are internal to the regulator valve, and the noise levels Nz, when the installation environment for the regulator valve is straight (straight pipe), reducer (a reducing pipe), and elbow (a bent pipe).

FIG. 5 is a diagram illustrating examples of cases wherein the installation environment for the regulator valve is straight (a straight pipe), reducer (a reducing pipe), and elbow (a bent pipe) (cases wherein the upstream side fluid pressure and downstream side fluid pressure detecting positions are internal to the regulator valve).

FIG. 6 is a diagram illustrating one example of a pressure ratio table showing the relationships between a relative flow coefficient Cv and the threshold value X_{Fv}th stored in the storing portion of a cavitation evaluating device according to Example.

FIG. 7 is a flowchart illustrating the cavitation evaluating operation executed by the cavitation evaluating device according to the Example.

FIG. 8 is a diagram illustrating an example of a pressure ratio table showing the relationships between a relative flow coefficient Cv, a first threshold value X_{Fv}th, a second threshold value X_{Fv}th2, and a third threshold value X_{Fv}th3 stored in the storing portion of a cavitation evaluating device according to Another Example.

FIG. 9 is a flowchart illustrating the cavitation evaluating operation executed by the cavitation evaluating device according to the Another Example.

FIG. 10 is a diagram illustrating noise levels when cavitation is and is not present during intermittent occurrence of cavitation.

FIG. 11 is a diagram illustrating the result of ⅓ octave band analysis of sound pressure data when cavitation is and is not present.

FIG. 12 is a diagram illustrating the relationship between the noise characteristics and the sound pressure characteristics at a specific frequency (8 kHz) to the pressure ratio X_{Fv} for an opening diameter for which the state of presence of cavitation has been difficult to infer.

FIG. 13 is a diagram illustrating the result of verifications of the pressure ratios X_{Fv} at onset and at the critical point for a regulator valve not used in creating the pressure ratio table through experimentation.

FIG. 14 is a diagram illustrating the state when finding the relationships between the pressure ratios X_{F} across the regulator valve and the noise levels.

FIG. 15 is a diagram illustrating the relationships (general trends) between the pressure ratios X_{F} across a regulator valve and the noise levels Nz.

FIG. 16 is a diagram illustrating a cavitation evaluating system that uses a conventional cavitation evaluating device.

FIG. 17 is a diagram illustrating the relationships between the pressure ratios X_{F} across the regulator valve and the sound levels Nz for the cases of the installation environment of the regulator valve being straight (a straight pipe), reducer (a reducing pipe), and elbow (a bent pipe).

FIG. 18 is a diagram illustrating examples of cases wherein the installation environment for the regulator valve is straight (a straight pipe), reducer (a reducing pipe), and elbow (a bent pipe) (for the case wherein the detecting positions for the upstream side fluid pressure and the downstream side fluid pressure are before and after the regulator valve).

### DETAILED DESCRIPTION

Examples according to the present invention will be explained below in detail, based on the drawings.

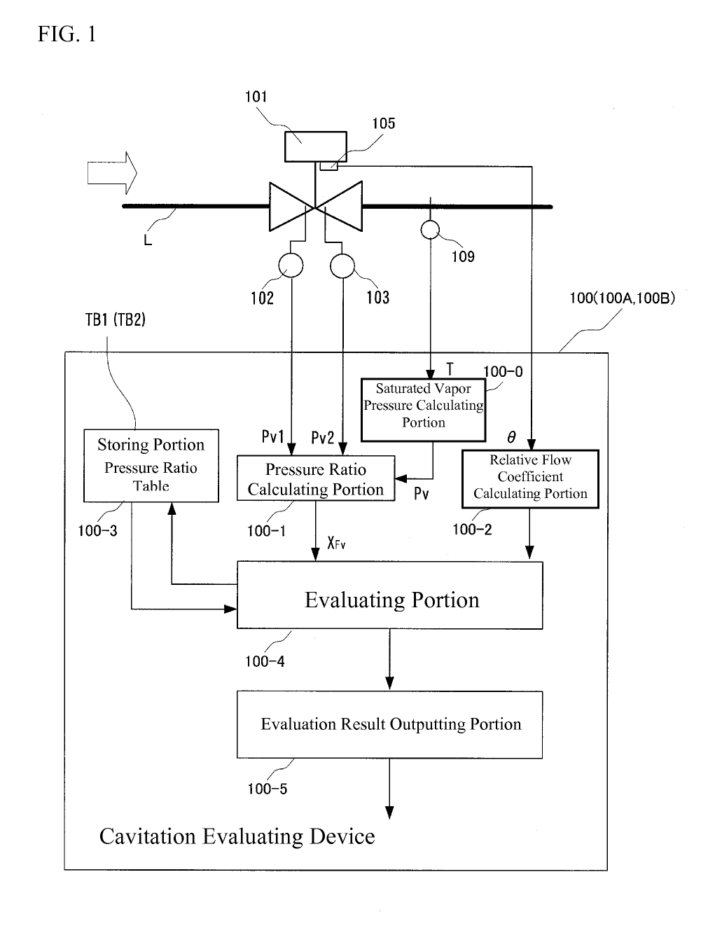

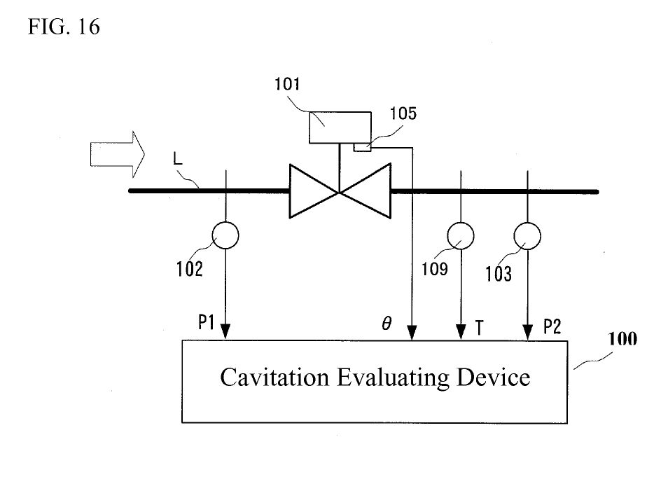

FIG. 1 is a diagram illustrating an example of a cavitation evaluating system for a regulator valve that uses the cavitation evaluating device according to the present invention. In this figure, codes that are the same as those in FIG. 16 indicate identical or equivalent structural elements as the structural elements explained in reference to FIG. 16, and explanations thereof are omitted.

In this cavitation evaluating system, a fluid pressure of the flow path that is internal to the regulator valve 101, on the upstream side of the valve plug in the regulator valve 101, is detected by the upstream side fluid pressure detecting device 102 as an upstream side fluid pressure Pv1, and a fluid pressure of a fluid stagnation portion in the flow path that is internal to the regulator valve 101, on the downstream side of the valve plug in the regulator valve 101, is detected by the downstream side fluid pressure detecting device 103 as a downstream side fluid pressure Pv2. The valve plug of the regulator valve 101, and the fluid stagnation portion within the flow path that is internal to the regulator valve 101, will be explained below.

Moreover, the upstream side fluid pressure Pv1 that is detected by the upstream side fluid pressure detecting device 102, the downstream side fluid pressure Pv2 that is detected by the downstream side fluid pressure detecting device 103, the fluid temperature T that is detected by the fluid temperature detecting device 109, and the degree of opening θ of the regulator valve 101 that is detected by the valve opening detecting device 105 are sent to the cavitation evaluating device 100, and whether or not there is cavitation in the regulator valve 101 is evaluated in the cavitation evaluating device 100.

Note that the cavitation evaluating device 100 in the present example shall be termed 100A in the below, and the conventional cavitation evaluating device 100, illustrated in FIG. 16, shall be termed 100C, in order to differentiate between the two.

Moreover, the cavitation evaluating device 100A shall be defined as a cavitation evaluating device according to the Example, to differentiate from the cavitation evaluating device 100B according to Another Example, described below. The cavitation evaluating devices 100A and 100B have, as the structural elements thereof, an upstream side fluid pressure detecting device 102, a downstream side fluid pressure detecting device 103, and a fluid temperature detecting device 109.

### Example

The cavitation evaluating device 100A includes a saturated vapor pressure calculating portion 100-0 that inputs the fluid temperature T from the fluid temperature detecting device 109 and calculates, from the fluid temperature T, the saturated vapor pressure Pv of the fluid, a pressure ratio calculating portion 100-1 for inputting the upstream side fluid pressure Pv1 from the upstream side fluid pressure detecting device 102, the downstream side fluid pressure Pv2 from the downstream side fluid pressure detecting device 103, and the saturated vapor pressure Pv from the saturated vapor pressure calculating portion 100-0 to calculate the pressure ratio X_{Fv} (X_{Fv}=(Pv2−Pv1)/(Pv1−Pv)) internal to the regulator valve 101, a relative flow coefficient calculating portion 100-2 for inputting the degree of valve opening θ of the regulator valve 101 from the valve opening detecting device 105, to calculate the relative flow coefficient Cv of the regulator valve 101, a storing portion 100-3, for storing a pressure ratio table TB1, described below, an evaluating portion 100-4, for evaluating whether or not there is cavitation in the regulator valve 101 from the pressure ratio X_{Fv} that is internal to the regulator valve 101, that was calculated by the pressure ratio calculating portion 100-1, the relative flow coefficient Cv that was calculated by the relative flow coefficient calculating portion 100-2, and the pressure ratio table TB1 that is stored in the storing portion 100-3, and an evaluation result outputting portion 100-5, for reporting, as the evaluation result, the evaluation result by the evaluating portion 100-4.

### The Fluid Stagnation Portion That Is Internal to Regulator Valve

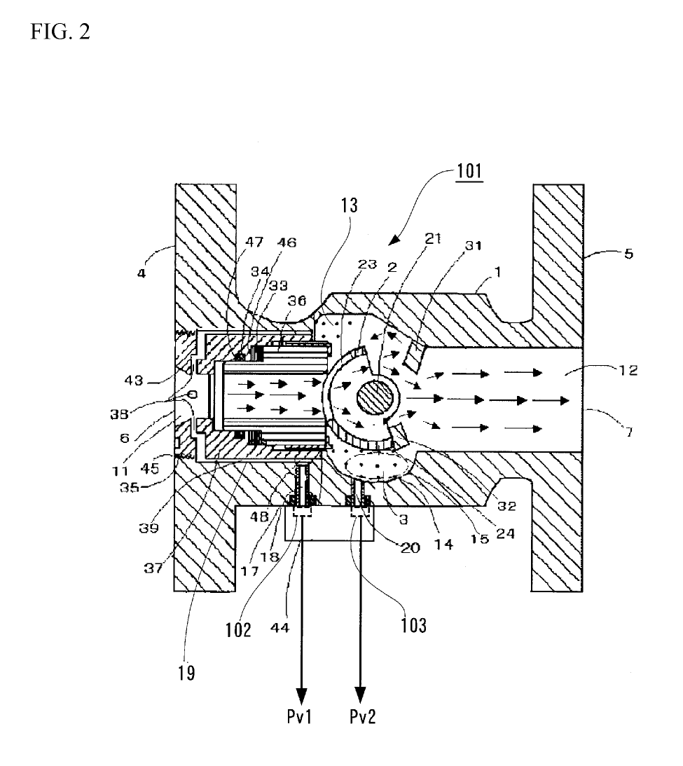

FIG. 2 shows a cross-sectional diagram of the critical portions of the regulator valve 101. In FIG. 2, 1 is a valve body, 2 is a valve plug, and 21 is a valve rod, wherein the valve rod 21 is secured to the valve plug 2. 4 is an upstream flange portion of the valve body 1, which abuts with a flange portion of an external pipe on the upstream side, not illustrated, and is connected thereto by a connecting member. 5 is a downstream flange portion of the valve body 1, which abuts with a flange portion of an external pipe on the downstream side, not illustrated, and is connected thereto by a connecting member. 11 is an upstream flow path, and is disposed on the upstream side of the valve plug 2. 6 is an inlet opening on the upstream end of the upstream flow path 11. 12 is a downstream flow path, and is disposed on the downstream side of the valve plug 2. 7 is an outlet opening on the downstream end of the downstream flow path 12.

A valve chamber 13 is provided between the upstream flow path 11 and the downstream flow path 12, where the valve plug 2 is contained within the valve chamber 13. The valve plug 2 is formed in essentially a hollow hemispherical shape having a flow path through hole 23, where the valve plug 2 is attached to the valve rod 21 that is perpendicular to the axis of the flow path, and is supported so as to be able to rotate in a plane that is perpendicular to the valve rod 21. Note that the arrows shown in the respective locations of the upstream flow path 11 and the downstream flow path 12 show schematically the directions and flow rates of the flows of the fluids in the respective locations.

31 is a portion of the valve body 1, a fully closed position limiting portion provided protruding from the valve body 1 so as to make contact with the valve plug 2 when the valve plug 2 is rotated to the fully closed position. 32 is a portion of the valve body 1, a fully open position limiting portion provided protruding from the valve body 1 so as to make contact with the valve plug 2 when the valve plug 2 is rotated to the fully open position. Note that in FIG. 2 the fully opened state of the valve plug 2 is illustrated, where the valve plug 2 contacts the fully open position limiting portion 32.

A seat ring 36, for tightly sealing the outer peripheral face 24 of the valve plug 2, a retainer 37 for retaining the seat ring 36 so as to be able to move in the axial direction of the upstream flow path 11, an elastic member 33 for pressing the seat ring 36 against the valve plug 2, and an O-ring 34 for sealing between the seat ring 36 and the retainer 37 are provided on the upstream side of the valve plug 2 that is internal to the valve body 1, where the seal structure of the seat ring is structured thereby.

The seat ring 36 is formed as a cylindrical unit that is open on both ends thereof, where the upstream side end portion is a small diameter portion with a thin wall structure, and, on the other hand, the downstream side end portion is a large diameter portion of a thick wall structure, and is pushed against the valve plug 2 by the elastic member 33. The retainer 37 is formed as a cylinder that is open on both ends thereof, and contains the seat ring 36 so as to be able to move freely in the axial direction of the upstream flow path 11, where male threads are formed on the outer peripheral face 35 of the upstream side end portion to screw into female threads that are formed on the inner peripheral face 45 of the upstream side opening portion of the valve body 1.

Moreover, the upstream side opening portion 43 of the retainer 37 has a tapered hole formed therein that becomes narrower toward the downstream side from the opening end face, where the inner diameter of the narrowest diameter portion is equal to the hole diameter of the seat ring 36. Moreover, a ring-shaped receiving portion 46, for receiving the elastic member 33, is formed between the inner peripheral face of the retainer 37 and the outer peripheral face of the seat ring 36. The receiving portion 46 is structured with a stepped portion that is formed on the outer peripheral face of the seat ring 36 and a stepped portion that is formed on the inner peripheral face of the retainer 37. Moreover, a ring-shaped groove 47 into which an O-ring 34 is fitted, is formed in the inner peripheral face of the retainer 37.

Four upstream side fluid pressure sampling portions 38, made from through holes that pass through the inner peripheral face and the outer peripheral face of the retainer 37 near to the smallest diameter portion of the tapered hole of the upstream side opening portion 43 of the retainer 37 are formed with equal spacing in the circumferential direction, and, additionally, four upstream side fluid pressure connecting ducts 39 are formed with equal spacing in the circumferential direction on the outer peripheral face on the downstream side from the part wherein the upstream side fluid pressure sampling portions 38 are formed. These upstream side fluid pressure connecting ducts 39 are made from grooves that are formed in the axial direction of the retainer, and the upstream side ends thereof are connected to the respective upstream side fluid pressure sampling portions 38. Furthermore, a ring-shaped groove 48 is formed connecting the downstream side ends of the four upstream side fluid pressure connecting ducts 39 on the outer peripheral face of the retainer 37.

Note that the dimension of the retainer 37 in the axial direction is set so that the opening portions in the inner peripheral face of the retainer 37 for the upstream side fluid pressure sampling portions 38 will be adequately separated from the position of contact between the seat ring 36 and the outer peripheral face of the valve plug 2, to enable the upstream side fluid pressure to be stabilized and sampled regardless of the degree of opening of the valve plug 2.

On the other hand, an upstream side fluid pressure guiding duct 18 is formed in the valve body 1 connecting each of the upstream side fluid pressure connecting ducts 39 through a ring-shaped groove 48 to an upstream/downstream fluid pressure detecting portion 44. The upstream side fluid pressure guiding duct 18 is formed between the upstream side inner peripheral face 19 of the valve body 1 in the vicinity of the valve plug 2 and the outer peripheral face 17 of the valve body 1 in the vicinity of the valve 2 to which the upstream/downstream fluid pressure detecting portion 44 is attached, and thus the fluid pressure of the upstream flow path 11 is guided from the upstream side fluid pressure sampling portions 38 through the upstream side fluid pressure connecting ducts 39, through the ring-shaped groove 48, through the upstream side fluid pressure guiding duct 18, to the upstream/downstream fluid pressure detecting portion 44.

The upstream/downstream fluid pressure detecting portion 44 is combining the upstream side fluid pressure detecting device 102 and the downstream side fluid pressure detecting device 103, and along with detecting the upstream side fluid pressure Pv1, detects, as the downstream side fluid pressure Pv2, the fluid pressure of a fluid stagnation part 3 of the fluid that is stagnated in a fluid stagnation portion 14 that is a space that is formed by the outer peripheral face 24 of the valve plug 2 within the downstream flow path 12 of the valve body 1 and the inner peripheral face 15 of the valve body 1 in the vicinity of the valve plug 2. The upstream side fluid pressure Pv1 and the downstream side fluid pressure Pv2 of the regulator valve 101, detected by the upstream/downstream fluid pressure detecting portion 44, are sent to the cavitation evaluating device 100A that is illustrated in FIG. 1. Note that the fluid pressure of the fluid stagnation part 3 that is stagnated in the fluid stagnation portion 14 is guided through the downstream side fluid pressure guiding duct 20 that passes through the inner peripheral face 15 of the valve body 1, which faces the fluid stagnation portion 14, and the outer peripheral face 17 of the valve body 1, to the upstream/downstream fluid pressure detecting portion 44.

### The Pressure Ratio Table

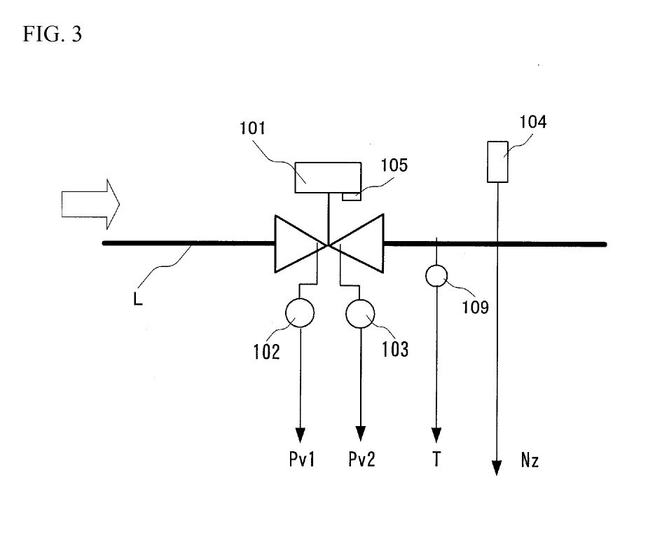

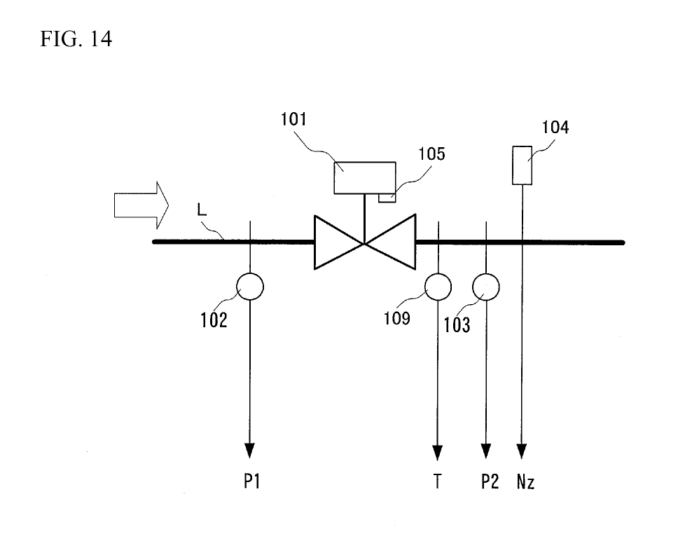

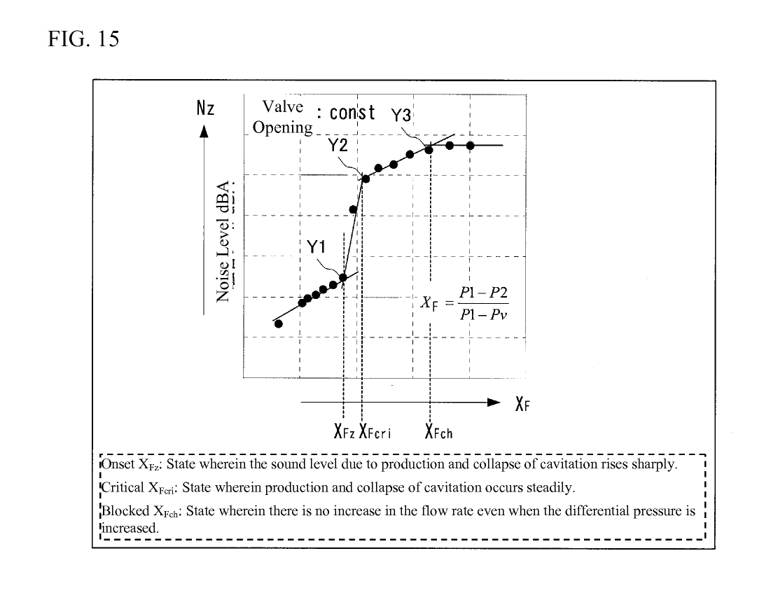

FIG. 3 shows the state wherein the relationships between the pressure ratios X_{Fv} that are internal to the regulator valve 101 and the sound levels are calculated. In this figure, codes that are the same as those in FIG. 14 indicate identical or equivalent structural elements as the structural elements explained in reference to FIG. 14, and explanations thereof are omitted. In this structure, the upstream side fluid pressure detecting device 102, as illustrated in FIG. 2, detects, as the upstream side fluid pressure Pv1, the fluid pressure of the flow path that is internal to the regulator valve 101 on the upstream side of the valve plug 2 of the regulator valve 101, and the downstream side fluid pressure detecting device 103 detects, as the downstream side fluid pressure Pv2, the fluid pressure of the fluid stagnation portion 14 within the flow path that is internal to the regulator valve 101 on the downstream side of the valve plug 2 in the regulator valve 101.

In order to find the relationships between the pressure ratios X_{Fv} that are internal to the regulator valve 101 and the noise levels, the degree of valve opening of the regulator valve 101 is held constant and the pressure ratio X_{Fv} that is internal to the regulator valve 101 is calculated as X_{Fv}=(Pv2−Pv1)/(Pv1−Pv). Given this, at this time the noise level Nz is measured by the noise meter 104. This operation is performed repetitively while varying the pressure ratio X_{Fv} that is internal to the regulator valve 101.

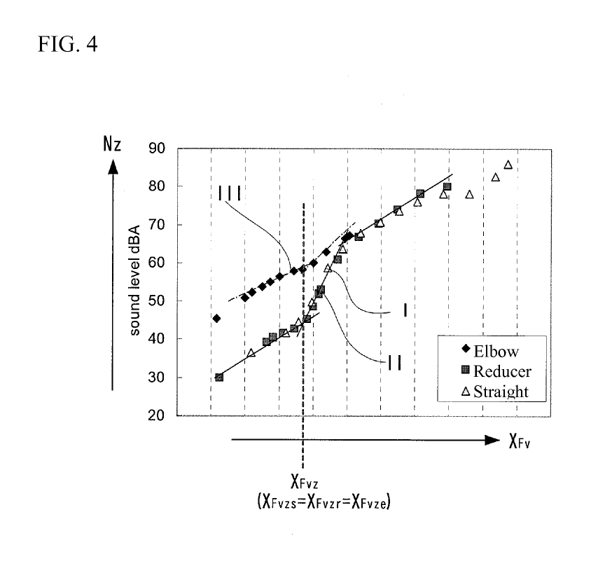

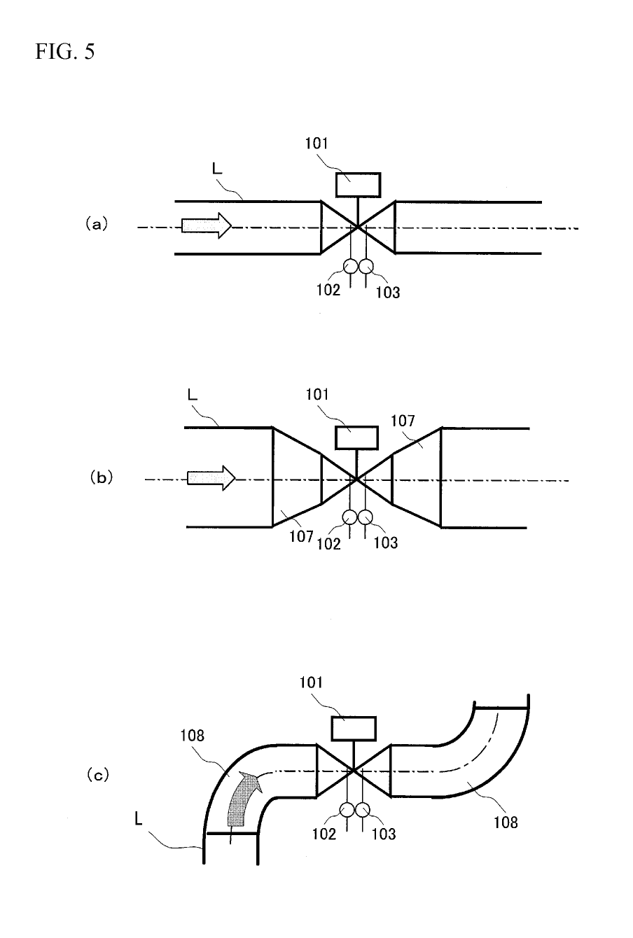

FIG. 4 shows the relationships between the pressure ratios X_{Fv} that are internal to the regulator valve 101 and the noise levels Nz for the cases wherein the installation environment for the regulator valve 101 is straight (FIG. 5(a)), a reducer (FIG. 5(b)), and an elbow (FIG. 5(c)). In FIG. 4, the Curve I shows the case wherein it is straight, the Curve II shows the case wherein it is a reducer, and the Curve III shows the case wherein it is an elbow.

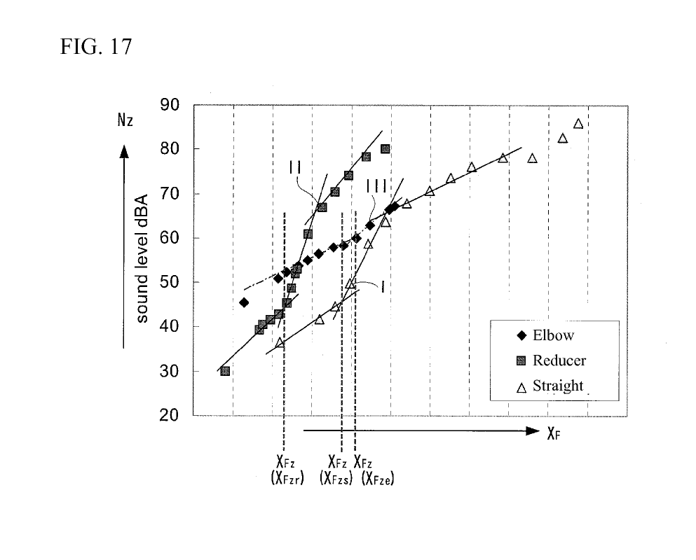

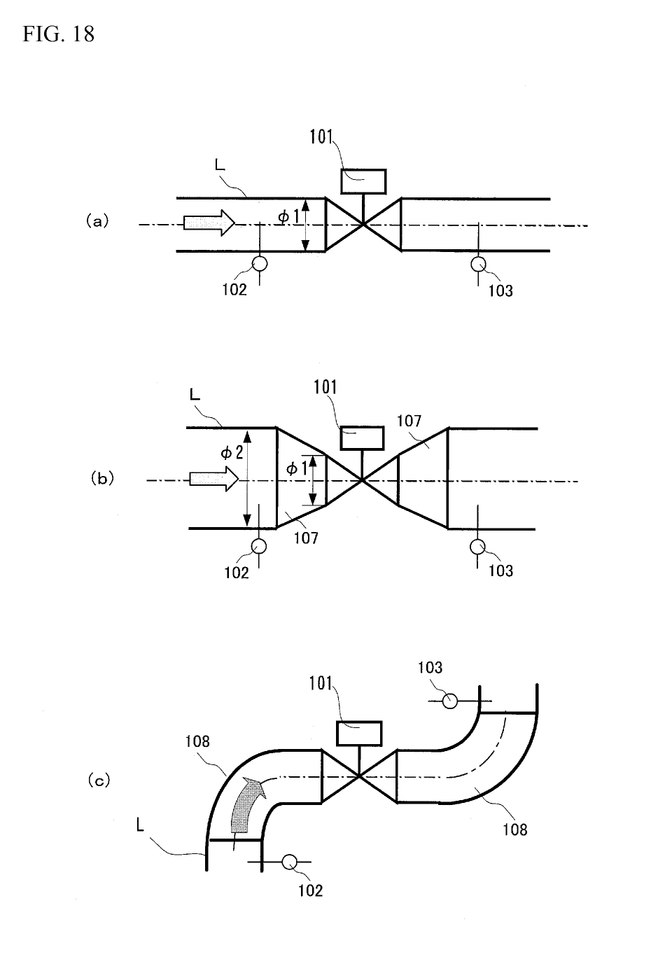

As can be understood from the Curves I, II, and III, shown in FIG. 4, the onset X_{Fvz}, which is the pressure ratio X_{Fv} at the time at which the occurrence of cavitation begins is essentially the same for the onset X_{Fvzs} for the case wherein the installation environment for the regulator valve 101 is straight, as it is or the onset X_{Fvzr} for the case of the reducer, as it is for the onset X_{Fvze} for the case of the elbow. That is, in the relationships between the pressure ratios X_{F} across the regulator valve 101 and the noise levels Nz, illustrated in FIG. 17, even though X_{Fzs}≠X_{Fzr}≠X_{Fze}, X_{Fvzs} is approximately equal to X_{Fvzr}, which is approximately equal to X_{Fvze}.

The cavitation that occurs in the regulator valve 101 is understood to be caused by the pressure on the upstream side of a restricting portion (a reduced flow portion) and the flow speed of the flow through the reduced flow portion across the valve plug 2 within the regulator valve 101. The upstream side fluid pressures P1 measured at locations that are separated at specific distances, in straight pipe lengths, from the regulator valve 101, will have pressure relationships that vary depending on the pressure loss conditions, such as reducers 107, elbows 108, or the like, that are installed before and after the regulator valve 101, even given identical flow speeds within the regulator valve 101. Because of this, the onset X_{Fz}, which is the pressure ratio X_{F} across the regulator valve 101 at the time at which the occurrence of cavitation starts in the regulator valve 101 varies depending on the installation environment for the regulator valve 101.

In contrast, because the pressure across the reduced flow portion within the regulator valve 101 is affected by the pressure loss of the regulator valve 101 alone, the pressure relationship does not change, there is little influence of the piping before and after the regulator valve 101. Because of this, the onset X_{Fvz,} which is the pressure ratio X_{Fv} that is internal to the regulator valve 101 at the time at which the occurrence of cavitation begins within the regulator valve 101 is essentially equal regardless of the installation environment of the regulator valve 101.

Because of this, in the present example the installation environment for the regulator valve 101 is set to, for example, straight, and the relationship between the pressure ratio X_{Fv} that is internal to the regulator valve 101 and the sound level Nz is found for each relative flow coefficient Cv of the regulator valve 101, where, in the relationships found between the pressure ratios X_{Fv} and the noise levels Nz, the pressure ratio X_{Fv} wherein the occurrence of cavitation starts (the onset X_{Fvz}) is defined as the threshold value X_{Fv}th, where the threshold value X_{Fv}th is established for various relative flow coefficients Cv, and the relationships between the relative flow coefficients Cv and the threshold values X_{Fv}th are stored in the storing portion 100-3 as a pressure ratio table TB1.

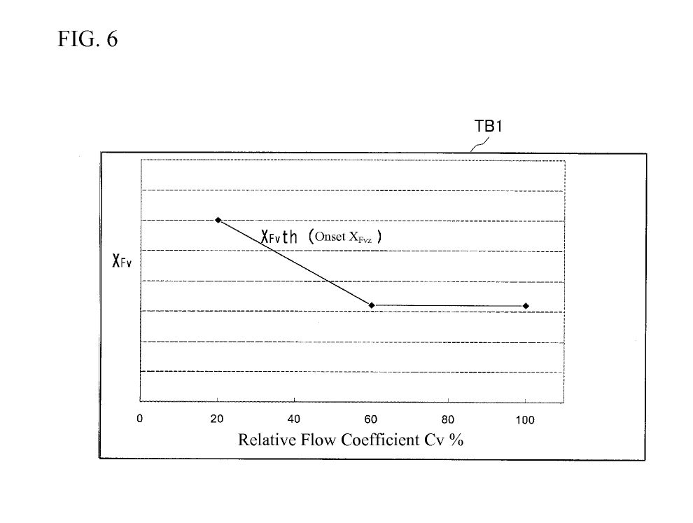

FIG. 6 shows one example of a pressure ratio table TB1 showing the relationships between the relative flow coefficients Cv and the threshold values X_{Fv}th stored in the storing portion 100-3. In the Example, there is only one such pressure ratio table TB1, and it is stored in the storing portion 100-3.

### Online Cavitation Evaluation

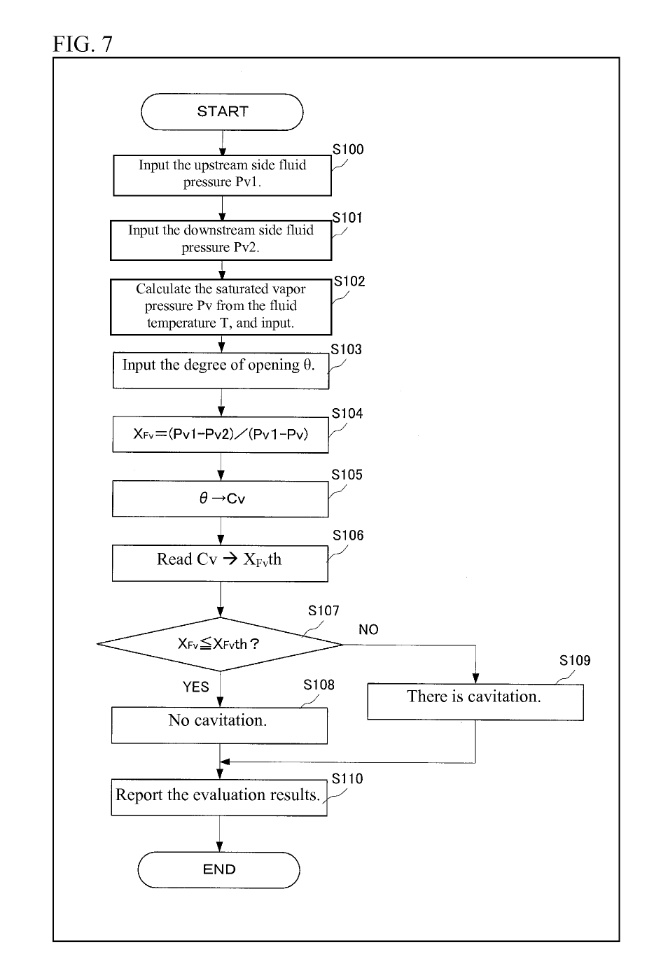

The cavitation evaluation operation executed by the cavitation evaluating device 100A according to the Example will be explained below in reference to the flow chart in FIG. 7. Note that the cavitation evaluating device 100A is embodied through hardware including a processor and a storage device, and through a program that, together with this hardware, causes the various functions to be embodied.

The cavitation evaluating device 100A, in Step S100, S101, S102, and S103, reads in the upstream side fluid pressure (the current upstream side fluid pressure) Pv1 from the upstream side fluid pressure detecting device 102, the downstream side fluid pressure (the current downstream side fluid pressure) Pv2 from the downstream side fluid pressure detecting device 103, the fluid temperature T from the fluid temperature detecting device 109, and the degree of opening (the current degree of opening) θ of the regulator valve 101 from the valve opening detecting device 105.

Following this, the pressure ratio internal to the regulator valve 101 (the current pressure ratio internal to the regulator valve 101) X_{Fv} is calculated as X_{Fv}=(Pv2−Pv1)/(Pv1−Pv) from the upstream side fluid pressure Pv1 and the downstream side fluid pressure Pv2, which have been read in, and the saturated vapor pressure Pv of the fluid, calculated from the fluid temperature T, by the saturated vapor pressure calculating portion 100-0 (Step S104). The calculation of the current internal pressure ratio X_{Fv} of the regulator valve 101 is performed by the pressure ratio calculating portion 100-1 of the cavitation evaluating device 100A.

Additionally, the cavitation evaluating device 100A finds the relative flow coefficient of the regulator valve 101 (the current relative flow coefficient) Cv from the degree of valve opening θ that has been read in for the regulator valve 101 (Step S105). The calculation of the current relative flow coefficient Cv of the regulator valve 101 is performed by the relative flow coefficient calculating portion 100-2 of the cavitation evaluating device 100A. The relationship between the degree of opening θ of the regulator valve 101 and the relative flow coefficient Cv, for example, is established in the relative flow coefficient calculating portion 100-2, where the relative flow coefficient Cv is found in accordance with the current degree of opening θ from this relationship.

The cavitation evaluating device 100A next reads out the threshold value X_{Fv}th corresponding to the relative flow coefficient Cv, found in Step S105, from the pressure ratio table TB1 that is stored in the storing portion 100-3 (referencing FIG. 6) (Step S106), and compares this threshold value X_{Fv}th that has been read out to the current pressure ratio X_{Fv} that is internal to the regulator valve 101, calculated in Step S104 (Step S107).

If here the current pressure ratio X_{Fv} that is internal to the regulator valve 101 is no more than the threshold value X_{Fv}th (YES in Step S107), then the evaluation is that there is no cavitation within the regulator valve 101 (Step S108), but if the current pressure ratio X_{Fv} that is internal to the regulator valve 101 exceeds the threshold value X_{Fv}th (NO in Step S107), then the evaluation is that there is cavitation within the regulator valve 101 (Step S109). The processing operations in these Steps S105 through S109 are performed by the evaluating portion 100-4 of the cavitation evaluating device 100A.

Given this, the cavitation evaluating device 100A reports, as the evaluation result, the evaluation result obtained in Step S108 or in Step S109 (Step S110). For example, it may be displayed on a display, not shown, or a buzzer may be sounded. The cavitation evaluating device 100A performs the processing operations in Step S100 through S110 periodically.

Note that the evaluation result in Step S110 need not be reported to the cavitation evaluating device 100A alone, but may also be sent to a higher-level device. This reporting of the evaluation result enables the operating method of the regulator valve 101 to be adjusted, to produce a longer service life for the regulator valve 101.

### Another Example

In the cavitation evaluating device 100A according to the Example, the onset X_{Fvz} that is the pressure ratio X_{Fv} at the time at which the occurrence of cavitation begins was defined as the threshold value X_{Fv}th, where a threshold value X_{Fv}th was established for each relative flow coefficient Cv, and the relationships between the relative flow coefficients Cv and the threshold values X_{Fv}th were stored in the storing portion 100-3 as the pressure ratio table TB1.

In contrast, in a cavitation evaluating device 100B according to the Another Example, the onset X_{Fvz} that is the pressure ratio X_{Fv} at the time at which the occurrence of cavitation starts in the regulator valve 101 is defined as a first threshold value X_{Fv}th1, the critical X_{Fveri} that is the pressure ratio X_{Fv} at the time at which the steady occurrence of cavitation begins in the regulator valve 101 is defined as X_{Fv}th2, and the blocked X_{Fvch}, which is the pressure ratio X_{Fv} at the time when a state is reached wherein the flow rate will not increase even when the differential pressure between the upstream and downstream sides of the regulator valve 101 is increased is defined as a third threshold value X_{Fv}th3, where the first threshold value X_{Fv}th1, the second threshold value X_{Fv}th2, and the third threshold value X_{Fv}th3 are established for the various relative flow coefficients Cv, and the relationships between the first threshold values X_{Fv}th1, the second threshold values X_{Fv}th2, the third threshold values X_{Fv}th3, and the relative flow coefficients Cv are stored in the storing portion 100-3 as a pressure ratio table TB2.

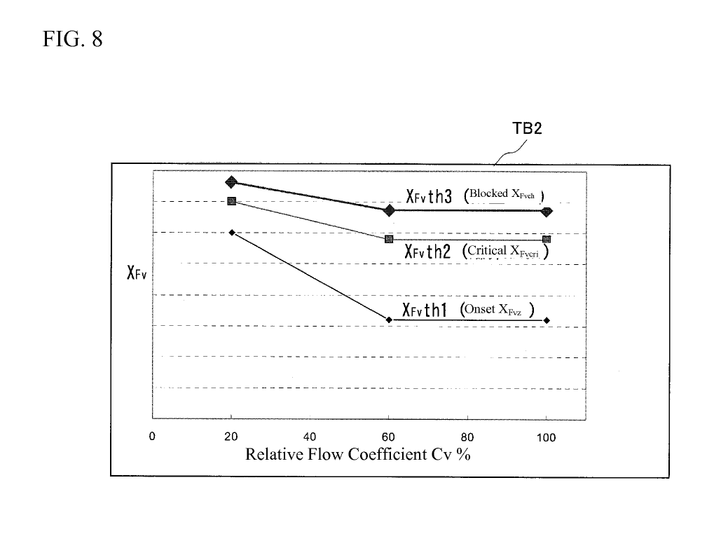

FIG. 8 illustrates one example of a pressure ratio table TB2 showing the relationships between relative flow coefficients Cv, first threshold values X_{Fv}th1, second threshold values X_{Fv}th2, and third threshold values X_{Fv}th3, stored in the storing portion 100-3. In the Another

Example, such a single pressure ratio table TB2 is established and stored in the storing portion 100-3.

### Online Cavitation Evaluation

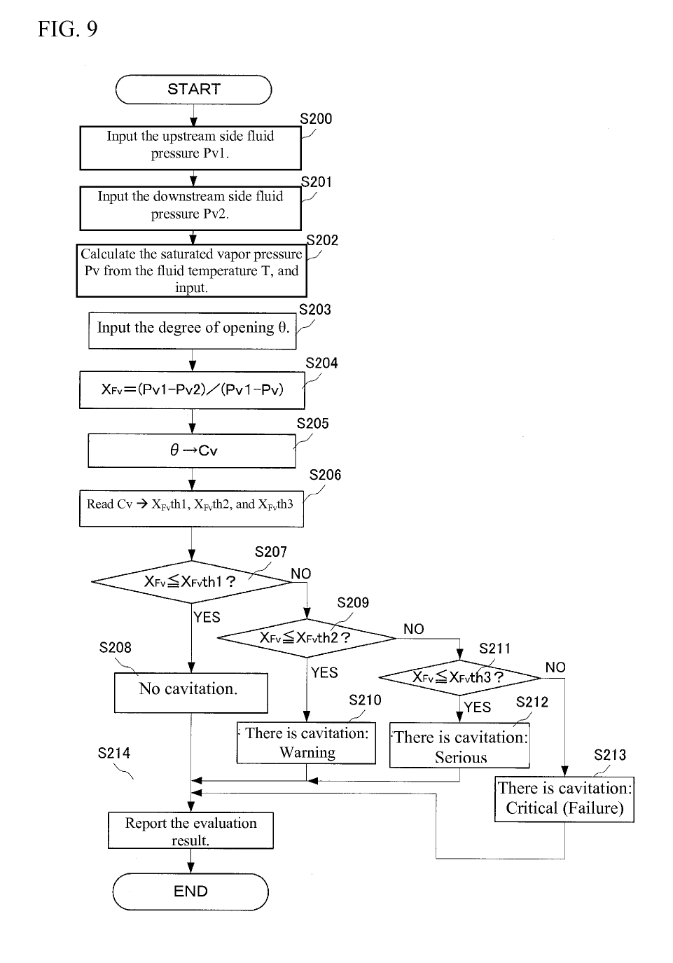

The cavitation evaluation operation executed by the cavitation evaluating device 100B according to the Another Example will be explained below in reference to the flow chart in FIG. 9.

The cavitation evaluating device 100B, in Step S200, S201, S202, and S203, reads in the upstream side fluid pressure (the current upstream side fluid pressure) Pv1 from the upstream side fluid pressure detecting device 102, the downstream side fluid pressure (the current downstream side fluid pressure) Pv2 from the downstream side fluid pressure detecting device 103, the fluid temperature T from the fluid temperature detecting device 109, and the degree of opening (the current degree of opening) θ of the regulator valve 101 from the valve opening detecting device 105.

Following this, the pressure ratio internal to the regulator valve 101 (the current pressure ratio internal to the regulator valve 101) X_{Fv} is calculated as X_{Fv}=(Pv2−Pv1)/(Pv1−Pv) from the upstream side fluid pressure Pv1 and the downstream side fluid pressure Pv2, which have been read in, and the saturated vapor pressure Pv of the fluid, calculated from the fluid temperature T, by the saturated vapor pressure calculating portion 100-0 (Step S204). The calculation of the current internal pressure ratio X_{Fv} of the regulator valve 101 is performed by the pressure ratio calculating portion 100-1 of the cavitation evaluating device 100B.

Additionally, the cavitation evaluating device 100B finds the relative flow coefficient of the regulator valve 101 (the current relative flow coefficient) Cv from the degree of valve opening θ that has been read in for the regulator valve 101 (Step S205). The calculation of the current relative flow coefficient Cv of the regulator valve 101 is performed by the relative flow coefficient calculating portion 100-2 of the cavitation evaluating device 100B. The relationship between the degree of opening θ of the regulator valve 101 and the relative flow coefficient Cv, for example, is established in the relative flow coefficient calculating portion 100-2, where the relative flow coefficient Cv is found in accordance with the current degree of opening θ from this relationship.

The cavitation evaluating device 100B next reads out the first threshold value X_{Fv}th1, the second threshold value X_{Fv}th2, and the third threshold value X_{Fv}th3 corresponding to the relative flow coefficient Cv, found in Step S205, from the pressure ratio table TB2 that is stored in the storing portion 100-3 (referencing FIG. 8) (Step S206),

Following this, the first threshold value X_{Fv}th1 that has been read in and the current pressure ratio X_{Fv} that is internal to the regulator valve 101, calculated in Step S204 are compared (Step S207), and if the current pressure ratio X_{Fv} that is internal to the regulator valve 101 is no more than the threshold value X_{Fv}th (YES in Step S207), then the evaluation is that there is no cavitation in the regulator valve 101 (Step S208).

If the current pressure ratio X_{Fv} that is internal to the regulator valve 101 exceeds the first threshold value X_{Fv}th1 (NO in Step S207), then the cavitation evaluating device 100B compares the current pressure ratio X_{Fv} that is internal to the regulator valve 101 to the second threshold value X_{Fv}th2 (Step S209).

Here if the current pressure ratio X_{Fv} that is internal to the regulator valve 101 is no more than the second threshold value X_{Fv}th2 (YES in Step S209), then the cavitation evaluating device 100B evaluates that cavitation is occurring within the regulator valve 101, and that the degree of the cavitation that is occurring is that of a “Warning” (Step S210).

If the current pressure ratio X_{Fv} that is internal to the regulator valve 101 exceeds the second threshold value X_{Fv}th2 (NO in Step S209), then the cavitation evaluating device 100B compares the current pressure ratio X_{Fv} that is internal to the regulator valve 101 to the third threshold value X_{Fv}th3 (Step S211).

Here if the current pressure ratio X_{Fv} that is internal to the regulator valve 101 is no more than the third threshold value X_{Fv}th3 (YES in Step S211), then the cavitation evaluating device 100B evaluates that cavitation is occurring within the regulator valve 101, and that the degree of the cavitation that is occurring is that of a “Serious” (Step S212).

If the current pressure ratio X_{Fv} that is internal to the regulator valve 101 exceeds the third threshold value X_{Fv}th3 (NO in Step S211), then the cavitation evaluating device 100B evaluates that cavitation is occurring within the regulator valve 101, and that the degree of the cavitation that is occurring is that of a “Critical (Failure)” (Step S213). The processing operations in these Steps S205 through S213 are performed by the evaluating portion 100-4 of the cavitation evaluating device 100B.

Given this, the cavitation evaluating device 100B reports, as the evaluation result, the evaluation result obtained in Step S208, S210, S212, or S213 (Step S214). For example, it may be displayed on a display, not shown, or a buzzer may be sounded with a different tone. The cavitation evaluating device 100B performs the processing operations in Step S200 through S214 periodically.

As can be understood from the explanation above, with the cavitation evaluating device 100A according to the Example, the pressure ratio X_{Fv} that is internal to the regulator valve 101 at the time at which the occurrence of cavitation begins in the regulator valve 101 (the onset X_{Fvz}) is defined as a threshold value X_{Fv}th, making it possible to evaluate whether or not there is cavitation using only one type of pressure ratio table TB that establishes the relationships between the threshold values X_{Fv}th and the relative flow coefficients Cv of the regulator valve 101, without being constrained by the installation environment of the regulator valve 101, such as straight versus elbow, etc. This makes it possible to perform high accuracy cavitation evaluations without preparing a plurality of types of pressure ratio tables (and without requiring large memory capacities) for variations in the installation environment (the pipe layouts) of the regulator valve 101.

Moreover, with the cavitation evaluating device 100B of the Another Example, the pressure ratio X_{Fv} that is internal to the regulator valve 101 at the time at which the occurrence of cavitation starts within the regulator valve 101 (the onset X_{Fvz}) is defined as a first threshold ratio X_{Fv}th1, the pressure ratio X_{Fv} at the time at which the steady occurrence of cavitation starts within the regulator valve 101 (the critical X_{Fveri}) is defined as a second threshold value X_{Fv}th2, and the pressure ratio X_{Fv} when a state is reached wherein the flow rate no longer increases when there is an increase in the differential pressure between the upstream side and the downstream side of the regulator valve 101 (the blocked X_{Fvch}) is defined as a third threshold value X_{Fv}th3, making it possible to use only a single type of pressure ratio table TB2 that establishes the relationships between the first threshold values X_{Fv}th1, the second threshold values X_{Fv}th2, the third threshold values X_{Fv}th3, and the relative flow coefficients Cv to evaluate the degree of cavitation that occurs, in addition to evaluating whether or not cavitation occurs, without being affected by constraints on the installation environment of the regulator valve 101, such as straight versus elbow, or the like. This makes it possible to perform high accuracy cavitation evaluations without preparing a plurality of types of pressure ratio tables (and without requiring large memory capacities) for variations in the installation environment (the pipe layouts) of the regulator valve 101. Moreover, this makes it possible to know not just whether or not there is cavitation, but the degree to which cavitation is occurring as well, making it possible, for example, to swap the regulator valve 101 when a warning has been issued, making it possible to extend the timing for swapping the regulator valves 101 depending on the operating conditions.

Moreover, with the cavitation evaluating devices 100A and 100B, the fluid pressure of a fluid stagnation portion 14, wherein stagnation is formed within the flow of the fluid within a flow path that is internal to the regulator valve 101 on the downstream side of the valve plug 2 of the regulator valve 101, is detected as the downstream side fluid pressure Pv2, and thus the downstream side fluid pressure Pv2 is detected at a fluid stagnation portion 14 that is not affected by dynamic pressure. Doing so makes it possible to calculate the pressure ratio X_{Fv} that is internal to the regulator valve 101 that is subject to only the pressure loss of the regulator valve 101, and tends to not be affected by the piping before and after the regulator valve 101, thereby enabling a further increase in the cavitation evaluation accuracy.

Furthermore, while, in the cavitation evaluating devices 100A and 100B, the fluid pressure of the flow path that is internal to the regulator valve 101 on the upstream side of the valve plug 2 in the regulator valve 101 is detected as the upstream side fluid pressure Pv1, fluids are caused to flow together from four upstream side fluid pressure sampling portions 38 that are formed at equal intervals in the circumferential direction and the pressure of the mixed fluid is detected as the upstream side fluid pressure Pv1, thus causing smoothing of the non-uniform pressure distribution due to biased flow, so as to not produce nonuniformity, due to biased flow, in the upstream side fluid pressure Pv1. Doing so makes it possible to calculate with even more accuracy the pressure ratio X_{Fv} that is internal to the regulator valve 101, enabling a further increase in the cavitation evaluation accuracy.

### Elimination of Water Flow Noise from the Noise Level

In the Example and the Another Example, set forth above, noise from cavitation and water flow noise are both included in the noise used with producing the pressure ratio tables TB1 and TB2, and there are cases wherein the effects of the water flow noise make it difficult for differences in the state of the cavitation to appear as differences in noise levels.

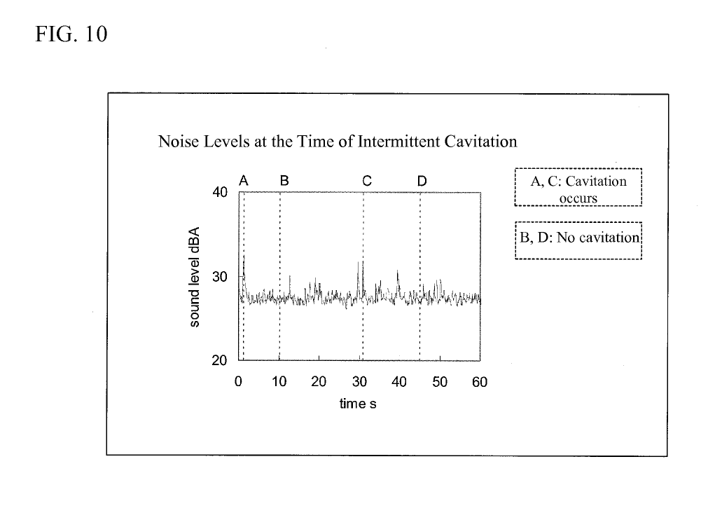

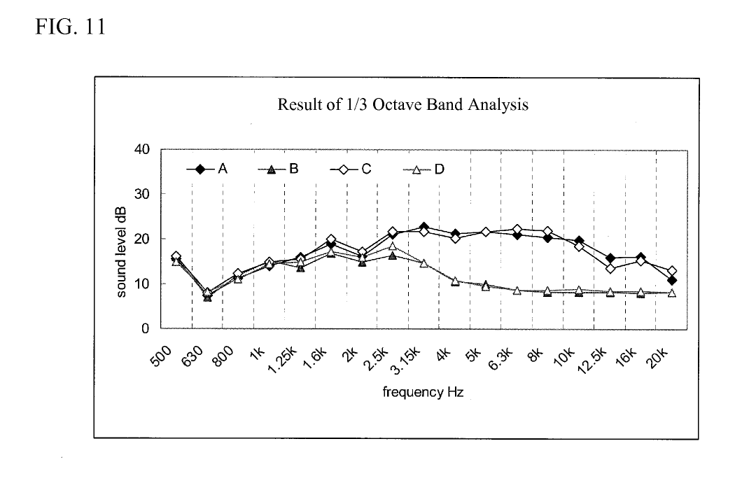

Given this, the inventors in the present application focused on the frequency components when bubbles collapse, and researched methods for estimating sound pressure characteristics of those frequency components. As a method for evaluating the frequency components, ⅓ octave band evaluation data analysis results were compared for when there was cavitation (point A and point C) and when there was no cavitation (point B and point D) in FIG. 10, through setting pressure conditions wherein cavitation occurred intermittently. The results are shown in FIG. 11. It can be understood from FIG. 11 that the difference between when there is cavitation and when there is no cavitation appears in the 2.5 kHz to 20 kHz frequency band.

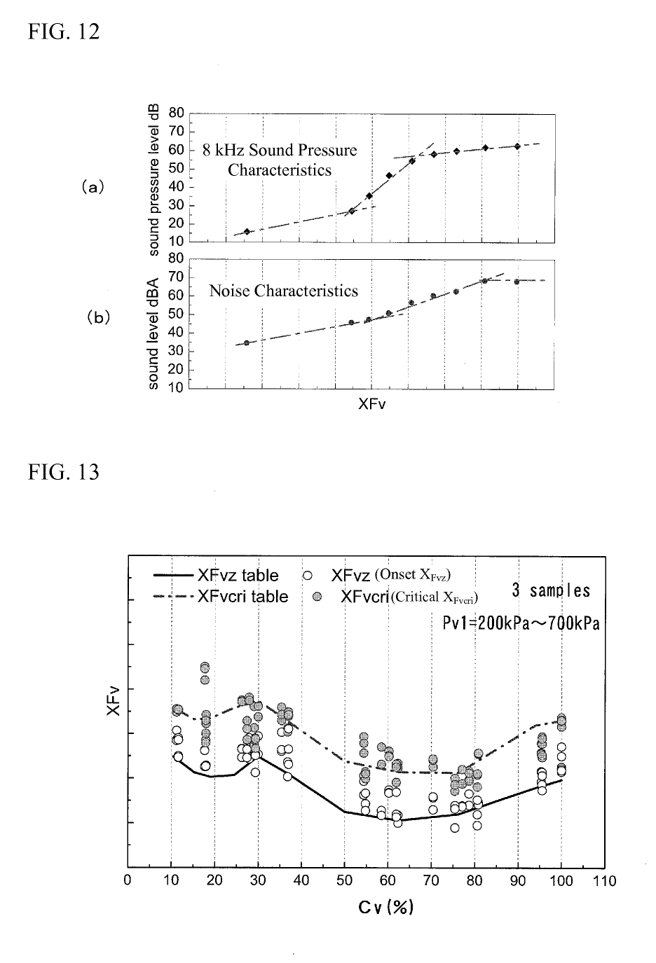

Given this result, these sound pressure characteristics were checked focusing on a frequency component of a specific frequency band (8 kHz, as one example). As one example, FIG. 12 shows the relationship between the pressure ratios X_{Fv} at an opening diameter wherein it is difficult to infer the state of occurrence of cavitation and the noise characteristics (FIG. 12(b)) and the sound pressure characteristics in the specific frequency band (FIG. 12(a)). It can be understood from FIG. 12 that the change is clearer in the sound pressure characteristics for the specific frequency band in FIG. 12(a) than it is in the noise characteristics in FIG. 12(b), making it easier to draw an approximated line for inferring the state of occurrence of cavitation.

From the above, in the cavitation evaluating devices 100A and 100B of the Example and the Another Example, preferably the pressure ratio tables TB1 and TB2 establish experimentally the relationships between the pressure ratios X_{Fv} that are internal to the regulator valve 101 and the sound pressure levels for a specific frequency band of the noise produced by the regulator valve 101 (with the sound pressure level for the 8 kHz frequency component as one example) for various relative flow coefficients Cv, and the pressure ratio tables TB1 and TB2 are created from these experimentally-derived relationships between the pressure ratios X_{Fv} and the sound pressure levels of the specific frequency bands (the sound pressure levels of the 8 kHz frequency component, as one example) for the various relative flow coefficients Cv.

### Reliability Evaluation for the Cavitation Evaluating Function

For reference, an actual regulator valve was used to evaluate the reliability of the cavitation evaluating function when a cavitation evaluating device according to the present invention was used.

As the procedure that was executed, first a pressure ratio table was created by deriving experimentally the relationships between the sound pressure levels and the pressure ratios X_{Fv} that were calculated from the pressures before and after the constriction for various relative flow coefficients Cv for the regulator valve. Given this, an evaluation program that incorporates logic for evaluating the state of occurrence of cavitation by comparing the table values and the pressure ratios X_{Fv} was created in order to evaluate reliability.

As the evaluation method, the reliability of the evaluation function was evaluated by experimentally checking the onset and critical point pressure ratios X_{Fv} in relation to a regulator valve for which no pressure ratio table had been constructed. The result of the cavitation evaluation is shown in FIG. 13.

The evaluation result was that it was essentially confirmed that appropriate evaluations are possible through the cavitation evaluating method using the pressure ratio table constructed from the relationships between the pressure ratios X_{Fv} and the sound pressure levels for the various relative flow coefficients Cv.

Note that while in the examples set forth above a pressure ratio table TB1 wherein the relationships between the relative flow coefficients Cv and the threshold values X_{Fv}th are established, and a pressure ratio table TB2 that establishes the relationships between the relative flow coefficients Cv and the threshold values X_{Fv}th1, X_{Fv}th2, and X_{Fv}th3, wherein the mathematical function of the degree of opening of the regulator valve 101 was the relative flow coefficient Cv were used, instead of the relative flow coefficient Cv, a proportion of the degree of valve opening θ relative to the maximum valve opening Amax may be used instead. Moreover, if the maximum valve opening Amax is a 100% opening, then the degree of opening θ itself may be used as the mathematical function for the valve opening of the regulator valve 101.

Moreover, while in the Example, set forth above, the onset X_{Fvz} was used as the threshold value X_{Fv}th, this threshold value X_{Fv}th need not necessarily be the onset X_{Fvz}, but rather may be a pressure ratio established arbitrarily between the onset X_{Fvz} and the critical X_{Fveri}. Moreover, this is true for the Another Example as well, where although the onset X_{Fvz} was used as the first threshold value X_{Fv}th1, the critical X_{Fveri} was used as the second threshold value X_{Fv}th2, and the blocking X_{Fvch} was used as the third threshold value X_{Fv}th3, of course these threshold values as well can be set somewhat higher or lower in the characteristics indicating the relationships between the pressure ratios X_{Fv} that are internal to the regulator valve 101 and the sound levels Nz.

While, in FIG. 1, the cavitation evaluating device 100 (100A or 100B) is provided external to the regulator valve 101, the cavitation evaluating device 100 (100A or 100B) may instead be provided internal to the regulator valve 101.

### Extended Examples

While the present invention has been explained above in reference to the examples, the present invention is not limited to the examples set forth above. The structures and details in the present invention may be varied in a variety of ways, as can be understood by one skilled in the art, within the scope of technology in the present invention.

1. A cavitation evaluating device for evaluating whether or not there is cavitation in a regulator valve in which a fluid is flowing, comprising:
an upstream side fluid pressure detecting portion that detects, as an upstream side fluid pressure Pv1, a fluid pressure of a flow path that is internal to the regulator valve, on the upstream side of a valve plug of the regulator valve;
a downstream side fluid pressure detecting portion that detects, as an downstream side fluid pressure Pv2, a fluid pressure of a fluid stagnation portion, that produces stagnation in a flow of a fluid in flow path that is internal to the regulator valve, on the downstream side of a valve plug of the regulator valve;
a fluid temperature detecting portion that detects, as a fluid temperature T, a temperature of the fluid;
a saturated vapor pressure calculating portion that calculates a saturated vapor pressure Pv of the fluid from the fluid temperature T that is outputted from the fluid temperature detecting portion;
a pressure ratio calculating portion that calculates a pressure ratio X_{Fv} that is internal to the regulator valve from the upstream side fluid pressure Pv1 that is detected by the upstream side fluid pressure detecting portion, the downstream side fluid pressure Pv2 that is detected by the downstream side fluid pressure detecting portion, and the saturated vapor pressure Pv that is calculated by the saturated vapor pressure calculating portion;
a storing portion that stores a pressure ratio table that establishes relationships between threshold values X_{Fv}th and a mathematical function of degrees of valve opening of the regulator valve, wherein the pressure ratio X_{Fv} that is internal to the regulator valve, at the time at which the occurrence of cavitation begins in the regulator valve, is defined as the threshold value X_{Fv}th; and
an evaluating portion that evaluates whether or not there is cavitation in the regulator valve by finding, from the pressure ratio table that is stored in the storing portion, the threshold value X_{Fv}th corresponding to a mathematical function of the current degree of opening of the regulator valve, and compares this threshold value X_{Fv}th that has been found to the current pressure ratio X_{Fv} that is internal to the regulator valve that was calculated by the pressure ratio calculating portion.

2. A cavitation evaluating device as set forth in claim 1, wherein:
the storing portion stores a pressure ratio table that establishes relationships between first threshold values X_{Fv}th1, second threshold values X_{Fv}th2, third threshold values X_{Fv}th3, and a mathematical function of the degrees of opening of the regulator valve, wherein the pressure ratio X_{Fv} that is internal to the regulator valve at the time at which the occurrence of cavitation in the regulator valve begins is defined as the first threshold value X_{Fv}th1, the pressure ratio X_{Fv} that is internal to the regulator valve at the time that the steady occurrence of cavitation within the regulator valve begins is defined as the second threshold value X_{Fv}th2, and the pressure ratio X_{Fv} that is internal to the regulator valve at the time that a state is achieved wherein the flow rate does not increase even when the differential pressure between upstream and downstream in the regulator valve is increased is defined as the third threshold value X_{Fv}th3; and
the evaluating portion finds, from the pressure ratio table stored in the storing portion, the first threshold value X_{Fv}th1, the second threshold value X_{Fv}th2, and the third threshold value X_{Fv}th3 corresponding to a mathematical function of the current degree of opening of the regulator valve, and compares these found first threshold value X_{Fv}th1, second threshold value X_{Fv}th2, and third threshold value X_{Fv}th3 to the current pressure ratio X_{Fv} that is internal to the regulator valve that was calculated by the pressure ratio calculating portion, to evaluate, in addition to whether or not there is cavitation within the regulator valve, the degree of cavitation that is present.

3. A cavitation evaluating device as set forth in claim 1, wherein:
relationships between the pressure ratios X_{Fv} that are internal to the regulator valve and sound pressure levels of a specific frequency component of noise that are produced by the regulator valve, for respective mathematical functions of the valve opening are found experimentally, and a pressure ratio table is constructed from the relationships of the pressure ratios X_{Fv} and the sound pressure levels for the specific frequency component, derived experimentally, for respective mathematical functions of the valve opening.

4. A cavitation evaluating device as set forth in claim 3, wherein:
the sound levels of the specific frequency component are sound levels of a 2.5 kHz to 20 kHz frequency band.

5. A cavitation evaluating device as set forth in claim 1, wherein:
the mathematical function of the degree of opening of the regulator valve is a relative flow coefficient.

6. A cavitation evaluating device as set forth in claim 1, wherein:
the mathematical function of the degree of opening of the regulator valve is the degree of opening.
